(19) United States
(12) Patent Application Publication
(10) Pub. No.: US 2020/0311849 A1
(43) Pub. Date: Oct. 1, 2020

(54) PARKING LOT MANAGEMENT DEVICE, PARKING LOT MANAGEMENT METHOD, AND PROGRAM

(71) Applicant: HONDA MOTOR CO., LTD., Tokyo (JP)

(72) Inventors: Junpei Noguchi, Wako-shi (JP); Chie Sugihara, Tokyo (JP); Yuta Takada, Tokyo (JP); Ryoma Taguchi, Tokyo (JP)

(21) Appl. No.: 16/824,867

(22) Filed: Mar. 20, 2020

(30) Foreign Application Priority Data
Mar. 29, 2019 (JP) 2019-068180

(51) Int. Cl. G06Q 50/30; G06Q 10/02

(52) U.S. Cl. CPC G06Q 50/30; G06Q 10/02

(57) ABSTRACT

A parking lot management device includes: a receiving unit configured to receive a reservation including designations of a reservation start time at which a vehicle enters a parking lot and a reservation end time at which the vehicle leaves the parking lot; a predicting unit configured to predict an arrival time at the parking lot in accordance with the arrival of the vehicle at a predetermined position; a control unit configured to perform control so that, when the arrival time predicted by the predicting unit is earlier than the reservation start time received by the receiving unit, it is determined whether the reservation start time is made earlier than the previously received reservation start time so that the vehicle is allowed to enter the parking lot, and when it is determined that a change in which the reservation start time is made earlier than the previously received reservation start time is possible, control is performed so that at least one of the reservation start time and the reservation end time is changed.

### CROSS-REFERENCE TO RELATED APPLICATION

Priority is claimed on Japanese Patent Application No. 2019-068180, filed Mar. 29, 2019, the content of which is incorporated herein by reference.

### BACKGROUND OF THE INVENTION

### Field of the Invention

The present invention relates to a parking lot management device, a parking lot management method, a program.

### Description of Related Art

In recent years, research has been conducted on automatically controlling vehicles. In connection with this, a technology for a parking lot with a reservation system has been described (for example, refer to Japanese Unexamined Patent Application, First Publication No. 2005-31766 (hereinafter, Patent Document 1)). Patent Document 1 describes that, by ascertaining road traffic situations, when the arrival of a vehicle is likely to be delayed for a reservation start time of a parking lot, the reservation start time is automatically changed to a scheduled arrival time estimated from position information of the vehicle.

### SUMMARY OF THE INVENTION

However, in the related art, a processing when a vehicle is expected to arrive earlier than a reservation start time has not been sufficiently considered as opposed to when the arrival of the vehicle is delayed for the reservation start time.

Also, in the related art, when a vehicle leaves a parking lot earlier than a reservation end time, an automatic driving vehicle being caused to appropriately leave a parking lot appropriately has not been considered sufficiently.

An aspect of the present invention was made in consideration of such circumstances, and an object of the present invention is to provide a parking lot management device, a parking lot management method, and a program which more flexibly receive a change in reservation time.

In order to accomplish the object for solving the above-described problems, the present invention adopts the following aspects.

(1): A parking lot management device according to an aspect of the present invention includes: a receiving unit configured to receive a reservation including designations of a reservation start time at which a vehicle enters a parking lot and a reservation end time at which the vehicle leaves the parking lot; a predicting unit configured to predict an arrival time at the parking lot in accordance with the arrival of the vehicle at a predetermined position; and a control unit configured to perform control so that, when the arrival time predicted by the predicting unit is earlier than the reservation start time received by the receiving unit, it is determined whether the reservation start time is made earlier than the previously received reservation start time so that the vehicle is allowed to enter the parking lot, and when it is determined that a change in which the reservation start time is made earlier than the previously received reservation start time is possible, control is performed so that at least one of the reservation start time and the reservation end time is changed.

(2): In the aspect of the above (1), the control unit may perform control so that a change in which the reservation end time is also made earlier than the previously received reservation end time is performed when the change in which the reservation start time is made earlier than the previously received reservation start time has been performed.

(3): In the aspect of the above (1) or (2), when it is determined whether the reservation start time is made earlier than the previously received reservation start time so that the vehicle is allowed to enter the parking lot, the control unit may perform a determination concerning whether a getting-on/off region in which a user of the vehicle gets on and off the vehicle is available in the parking lot by including the determination in determination conditions regarding whether the reservation start time can be made earlier than the previously received reservation start time.

(4): In the aspect of the above (3), when the reservation start time has been made earlier than the previously received reservation start time, the control unit may cause the vehicle to enter the getting-on/off region on the basis of the reservation start time if the vehicle is not allowed to enter the parking lot and is allowed to enter the getting-on/off region.

(5): In the aspect of any one of the above (1) to (4), the parking lot management device may further include: a calculation unit configured to calculate a parking fee in accordance with a time at which the vehicle is parked in the parking lot; and an estimating unit configured to estimate a congested state of the parking lot in the future, wherein the estimating unit may estimate a congested state at the reservation start time received in advance by the receiving unit and a congested state at the arrival time, the control unit may determine whether a change in which the reservation start time is made earlier than the previously received reservation start time is possible when the estimating unit estimates that the congested state at the reservation start time is equal to or higher than a predetermined degree of congestion and a degree of congestion at the reservation start time is higher than that of the arrival time, and the calculation unit may apply an incentive to the parking fee when the control unit determines that the change in which the reservation start time is made earlier than the previously received reservation start time is possible and the reservation start time of the vehicle is made earlier than the previously received reservation start time.

(6): In the aspect of the above (5), the incentive may include calculating the parking fee by regarding the reservation start time received in advance by the receiving unit as a use start time when the control unit determines that the change in which the reservation start time is made earlier than the previously received reservation start time is possible.

(7): In the aspect of the above (5) or (6), the control unit may determine whether the change in which the reservation start time is made earlier than the previously received reservation start time is possible when the congested state at the reservation start time estimated by the estimating unit is less than a predetermined degree of congestion, and the calculation unit may calculate the parking fee using the arrival time as a reservation start time when the control unit determines that the change in which the reservation start time is made earlier than the previously received reservation start time is possible.

(8): A parking lot management device according to an aspect of the present invention includes: a receiving unit configured to receive a reservation including designation of a reservation end time at which a vehicle leaves a parking lot and a parking lot leaving request including a scheduled getting-on time of a user of the vehicle getting on the vehicle; and a control unit configured to determine whether the vehicle is allowed to leave the parking lot at the scheduled getting-on time when the scheduled getting-on time received by the receiving unit is earlier than the reservation end time received by the receiving unit and to perform control so that the reservation end time is changed to the scheduled getting-on time when it is determined that the vehicle is allowed to leave the parking lot at the scheduled getting-on time.

(9): In the aspect of the above (8), the control unit may perform a determination concerning whether the vehicle is allowed to leave the parking lot by including a determination concerning whether a getting-on/off region in which the user gets on and off the vehicle is available in the parking lot in determination conditions regarding whether the reservation end time can be made earlier than the previously received reservation end time and makes a reservation so that the vehicle is able to use the getting-on/off region when it is determined that the vehicle is allowed to leave the parking lot at the scheduled getting-on time.

(10): In the aspect of the above (8) or (9), the parking lot management device may further include: a calculation unit configured to calculate a parking fee in accordance with a time at which the vehicle is parked in the parking lot; and an estimating unit configured to estimate a congested state of the parking lot in the future, wherein the estimating unit may estimate a congested state at the reservation end time and a congested state at the scheduled getting-on time, the control unit may determine whether the reservation end time is able to be changed to the scheduled getting-on time earlier than the reservation end time when the estimating unit estimates that the congested state at the reservation end time is equal to or higher than a predetermined degree of congestion and a degree of congestion at the reservation end time is higher than that of the scheduled getting-on time, and the calculation unit may apply an incentive to the parking fee when the control unit determines that a change in which the reservation end time is made earlier than the previously received reservation end time is possible and the reservation end time of the vehicle is made earlier than the previously received reservation end time.

(11): In the aspect of the above (10), the incentive may include calculating the parking fee by regarding the scheduled getting-on time as a use end time when the control unit determines that the change in which the reservation end time is able to be changed to the scheduled getting-on time earlier than the reservation end time.

(12): In the aspect of the above (10) or (11), the control unit may determine whether the reservation end time is able to be changed to the scheduled getting-on time earlier than the reservation end time when the congested state at the reservation end time estimated by the estimating unit is less than a predetermined degree of congestion, and the calculation unit may calculate the parking fee in accordance with the reservation end time when the control unit determines that the change in which the reservation end time is made earlier than the previously received reservation end time is possible and the reservation end time of the vehicle is made earlier than the previously received reservation end time.

(13): A parking lot management method according to another aspect of the present invention causing a computer to execute: receiving a reservation including designations of a reservation start time at which a vehicle enters a parking lot and a reservation end time at which the vehicle leaves the parking lot and a parking lot leaving request including a scheduled getting-on time of a user of the vehicle getting on the vehicle, predicting an arrival time at the parking lot in accordance with the arrival of the vehicle at a predetermined position, performing a determination concerning whether the reservation start time is made earlier than the previous received reservation start time so that the vehicle is allowed to enter the parking lot when the predicted arrival time is earlier than the reservation start time and performing control so that at least one of the reservation start time and the reservation end time is changed when it is determined that a change in which the reservation start time is made earlier than the previously received reservation start time is possible, and performing a determination concerning whether the vehicle is allowed to leave the parking lot at the scheduled getting-on time when the scheduled getting-on time is earlier than the reservation end time and performing control so that the reservation end time is changed to the scheduled getting-on time when it is determined that the vehicle is allowed to leave the parking lot at the scheduled getting-on time.

(14): A non-transitory computer-readable storage medium according to still another aspect of the present invention which stores a program causing a computer to execute: receiving a reservation including designations of a reservation start time at which a vehicle enters a parking lot and a reservation end time at which the vehicle leaves the parking lot and a parking lot leaving request including a scheduled getting-on time of a user of the vehicle getting on the vehicle, predicting an arrival time at the parking lot in accordance with the arrival of the vehicle at a predetermined position, performing a determination concerning whether the reservation start time is made earlier than the previous received reservation start time so that the vehicle is allowed to enter the parking lot when the predicted arrival time is earlier than the reservation start time and performing control so that at least one of the reservation start time and the reservation end time is changed when it is determined that a change in which the reservation start time is made earlier than the previously received reservation start time is possible, and performing a determination concerning whether the vehicle is allowed to leave the parking lot at the scheduled getting-on time when the scheduled getting-on time is earlier than the reservation end time and performing control so that the reservation end time is changed to the scheduled getting-on time when it is determined that the vehicle is allowed to leave the parking lot at the scheduled getting-on time.

According to an aspect of the present invention, it is possible to more flexibly receive a change in reservation time.

### BRIEF DESCRIPTION OF THE DRAWINGS

FIG. 1 is a constitution diagram of a vehicle system 1 using an automatic driving control device 100.

FIG. 2 is a functional constitution diagram of a first control unit 120 and a second control unit 160.

FIG. 3 is a diagram schematically illustrating a scene in which an automatic traveling parking event is performed.

FIG. 4 is a diagram illustrating an example of a constitution of a parking lot management device 400.

FIG. 5 is a diagram for explaining an example of changing a reservation start time.

FIG. 6 is a diagram for explaining another example of changing a reservation start time.

FIG. 7 is a diagram for explaining another example of changing a reservation start time.

FIG. 8 is a diagram for explaining another example of changing a reservation start time.

FIG. 9 is a diagram for explaining an example of changing a reservation end time.

FIG. 10 is a flowchart for describing an example of a flow of a parking lot entry process of a parking lot management device 400.

FIG. 11 is a flowchart for describing an example of the flow of the parking lot entry process of the parking lot management device 400.

FIG. 12 is a flowchart for describing an example of a flow of a parking lot leaving process of the parking lot management device 400.

FIG. 13 is a diagram illustrating an example of a hardware constitution of the parking lot management device 400 in an embodiment.

### DETAILED DESCRIPTION OF THE INVENTION

An embodiment of a parking lot control device, a parking lot control method, and a program of the present invention will be described below with reference to the drawings.

### [Overall Constitution]

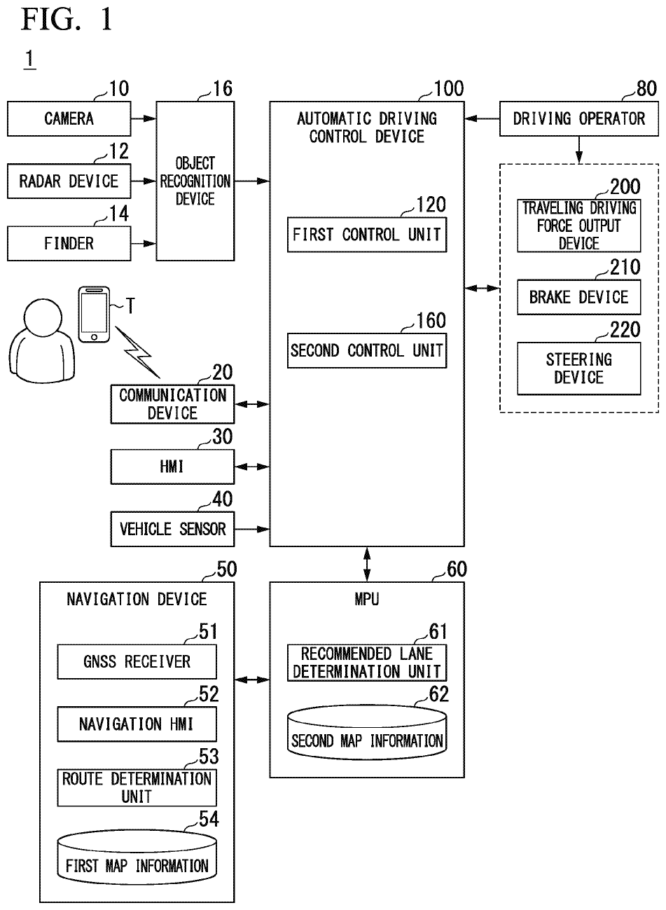

FIG. 1 is a constitution diagram of a vehicle system 1 using an automatic driving control device 100. A vehicle having the vehicle system 1 installed therein is, for example, a vehicle such as a two-wheeled vehicle, a three-wheeled vehicle, or a four-wheeled vehicle and its driving source is an internal combustion engine such as a diesel or a gasoline engine, an electric motor, or a combination thereof. An electric motor operates using electric power generated through an electric generator connected to an internal combustion engine or discharged electric power of a secondary battery or a fuel cell.

The vehicle system 1 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, the automatic driving control device 100, a traveling driving force output device 200, a brake device 210, and a steering device 220. These devices and apparatuses are connected to each other through a multiplex communication line such as a control unit area network (CAN) communication line, a serial communication line, a wireless communication network, or the like. The constitution illustrated in FIG. 1 is merely an example and a part of the constitution may be omitted or another constitution may be added.

The camera 10 is, for example, a digital camera using a solid-state imaging device such as a charge coupled device (CCD) or a complementary metal oxide semiconductor (CMOS). The camera 10 may be attached to any place of the vehicle having the vehicle system 1 installed therein (hereinafter referred to as a “vehicle M”). When imaging a portion in front of the vehicle, the camera 10 is attached to an upper portion of a front windshield, a rear surface of a rearview mirror, or the like. The camera 10, for example, periodically and repeatedly captures the periphery of the vehicle M. The camera 10 may be a stereo camera.

The radar device 12 radiates radio waves such as millimeter waves around the vehicle M and detects radio waves (reflected waves) reflected by an object to detect at least a position (a distance and a direction) of the object. The radar device 12 may be attached to any place of the vehicle M. The radar device 12 may detect a position and a speed of an object using a frequency modulated continuous wave (FM-CW) method.

The finder 14 is a light detection and ranging (LIDAR). The finder 14 irradiates the periphery of the vehicle M with light and measures scattered light. The finder 14 detects a distance to a target on the basis of a time between light emission and light reception. The irradiated light is, for example, a pulsed laser beam. The finder 14 may be attached to any place of the vehicle M.

The object recognition device 16 recognizes a position, a type, a speed, and the like of an object by performing a sensor fusion process on the detection results of some or all of the camera 10, the radar device 12, and the finder 14. The object recognition device 16 outputs the recognition result to the automatic driving control device 100. The object recognition device 16 may output the detection results of the camera 10, the radar device 12, and the finder 14 to the automatic driving control device 100 as they are. The object recognition device 16 may be omitted from the vehicle system 1.

The communication device 20 communicates with a terminal used by a user of the vehicle (hereinafter referred to as a “user terminal T”), another vehicle or a parking lot management device (which will be described later) present around the vehicle M, or various server devices, for example, using a cellular network, a Wi-Fi network, the Bluetooth (registered mark), a dedicated short range communication (DSRC), or the like.

The HMI 30 presents various information to the user of the vehicle M and receives an input operation by the user. The HMI 30 includes various display devices, speakers, buzzers, touch panels, switches, keys, and the like.

The vehicle sensor 40 includes a vehicle speed sensor configured to detect a speed of the vehicle M, an acceleration sensor configured to detect acceleration, a yaw rate sensor configured to detect an angular velocity around a vertical axis, a direction sensor configured to detect a direction of the vehicle M, and the like.

The navigation device 50 includes, for example, a global navigation satellite system (GNSS) receiver 51, a navigation HMI 52, and a route determination unit 53. The navigation device 50 holds first map information 54 in a storage device such as a hard disk drive (HDD) or a flash memory. The GNSS receiver 51 identifies a position of the vehicle M on the basis of signals received from GNSS satellites. The position of the vehicle M may be identified or supplemented through an inertial navigation system (INS) using an output of the vehicle sensor 40. The navigation HMI 52 includes a display device, a speaker, a touch panel, a key, and the like. The navigation HMI 52 may be partially or entirely shared with the above-described HMI 30. The route determination unit 53 may, for example, determine a route to a destination input by the user (hereinafter referred to as a “route on a map”) using the navigation HMI 52 from a position (or an any input place) of the vehicle M identified through the GNSS receiver 51 with reference to the first map information 54. The first map information 54 is, for example, information in which a road shape is represented by a link indicating a road and a node connected through the link. The first map information 54 may include a curvature of a road, point of interest (POI) information, and the like. The route on a map is output to the MPU 60. The navigation device 50 may perform route guidance using the navigation HMI 52 on the basis of the route on a map. The navigation device 50 may be realized, for example, using functions of a smartphone or a terminal device such as a tablet terminal owned by the user. The navigation device 50 may transmit a current position and a destination to a navigation server via the communication device 20 and acquire a route equivalent to the route on a map from the navigation server.

The MPU 60 includes, for example, a recommended lane determination unit 61 and holds second map information 62 in a storage device such as an HDD or a flash memory. The recommended lane determination unit 61 divides the route on a map provided from the navigation device 50 into a plurality of blocks (for example, performs division every 100 [m] in a vehicle traveling direction) and determines a recommended lane for each of the blocks with reference to the second map information 62. The recommended lane determination unit 61 performs a determination concerning a lane on which the vehicle is to travel with respect to the leftmost lane.

When there is a branch place in the route on a map, the recommended lane determination unit 61 determines a recommended lane so that the vehicle M can travel on a reasonable route for going forward to a branch destination.

The second map information 62 is more accurate map information than the first map information 54. The second map information 62 includes, for example, information on a center of a lane, information on a boundary of a lane, and the like. Furthermore, the second map information 62 may include road information, traffic regulation information, address information (an address/a postal code), facility information, telephone number information, and the like. The second map information 62 may be updated at any time through the communication device 20 communicating with another device.

The driving operator 80 includes, for example, an accelerator pedal, a brake pedal, a shift lever, a steering wheel, a steer of another type, a joystick, and other manipulators. The driving operator 80 has a sensor configured to detect an amount of manipulation or the presence or absence of manipulation attached thereto and the detection results thereof are output to the automatic driving control device 100 or some or all of the traveling driving force output device 200, the brake device 210, and the steering device 220.

The automatic driving control device 100 includes, for example, a first control unit 120 and a second control unit 160. The first control unit 120 and the second control unit 160 are realized, for example, through a hardware processor such as a central processing unit (CPU) configured to execute a program (software). Furthermore, some or all of these constituent elements may be implemented through hardware (a circuit unit; including a circuitry) such as a large scale integration (LSI), an application specific integrated circuit (ASIC), a field-programmable gate array (FPGA), and a graphics processing unit (GPU) or may be realized through software and hardware in cooperation with each other. The program may be stored in advance in a storage device (a storage device including non-transitory storage media) such as an HDD or a flash memory of the automatic driving control device 100 or stored in a removable storage medium such as a digital versatile disc (DVD) and a compact disk (CD)-read only memory (ROM) and may be installed in the HDD or the flash memory of the automatic driving control device 100 when a storage medium (a non-transitory storage medium) is installed in a drive device.

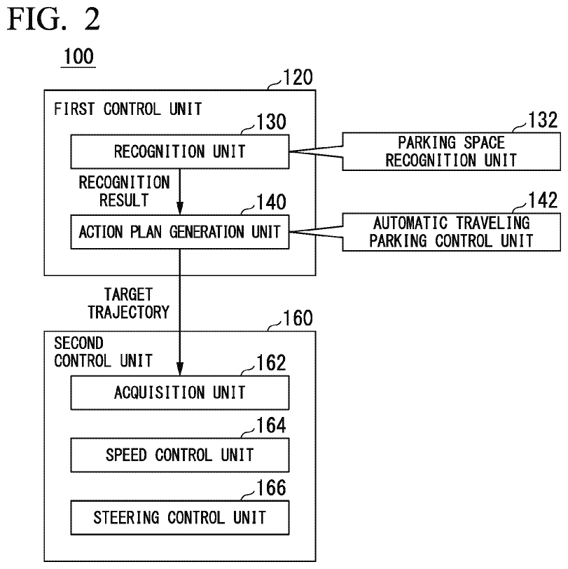

FIG. 2 is a functional constitution diagram of the first control unit 120 and the second control unit 160. The first control unit 120 includes, for example, a recognition unit 130 and an action plan generation unit 140. The first control unit 120 realizes, for example, a function using an artificial intelligence (AI) and a function using a pre-given model in parallel. For example, a function of “recognizing an intersection” may be realized by performing the recognition of the intersection using deep learning or the like and the recognition based on predetermined conditions (such as a signal which can be subjected to pattern matching and a road sign) in parallel and scoring the recognitions for both and comprehensively performing evaluation. Thus, the reliability of automatic driving is ensured.

The recognition unit 130 recognizes a state such as a position, a speed, and acceleration of an object around the vehicle M on the basis of information input through the object recognition device 16 from the camera 10, the radar device 12, and the finder 14. The position of the object is recognized, for example, as a position on absolute coordinates having a representative point (the center of gravity, a center of a drive shaft, or the like) of the vehicle M as the origin and is used for control. The position of the object may be represented by a representative point such as the center of gravity or a corner of the object or may be represented by a represented region. The “state” of the object may include acceleration or jerk of the object or an “action state” (for example, whether the vehicle is changing its lane or is attempted to change its lane).

Also, the recognition unit 130 recognizes, for example, a lane in which the vehicle M is traveling (a traveling lane).

For example, the recognition unit 130 recognizes a traveling lane by comparing a pattern of road division lines obtained from the second map information 62 (for example, an arrangement of solid lines and broken lines) with a pattern of road division lines around the vehicle M recognized from an image captured using the camera 10. The recognition unit 130 may recognize a traveling lane by recognizing a traveling road boundary (a road boundary) including a road division line, a road shoulder, a curb, a median strip, a guardrail, and the like, without being limited to the road division lines. In this recognition, the position of the vehicle M acquired from the navigation device 50 and the processing result using the INS may be added. Furthermore, the recognition unit 130 recognizes a temporary stop line, an obstacle, a red light, a tollgate, and other road events.

The recognition unit 130 recognizes a position and a posture of the vehicle M with respect to a traveling lane when recognizing the traveling lane. The recognition unit 130 may recognize, for example, a deviation from a center of a lane of a reference point of the vehicle M and an angle with respect to a line connecting centers of a lane of a traveling direction of the vehicle M as a relative position and a posture of the vehicle M with respect to the traveling lane. Instead, the recognition unit 130 may recognize a position or the like of a reference point of the vehicle M with respect to side end portion (a road division line or a road boundary) of any one of traveling lanes as a relative position of the vehicle M with respect to the traveling lane.

The recognition unit 130 includes a parking space recognition unit 132 starting-up in an automatic traveling parking event which will be described later. Details of a function of the parking space recognition unit 132 will be described later.

The action plan generation unit 140 generates a target trajectory in which the vehicle M travels automatically (independent of a driver's operation) in the future so that, in principle, the vehicle M travels in a recommended lane determined using the recommended lane determination unit 61 and can further cope with the surrounding situation of the vehicle M. The target trajectory includes, for example, a speed element. For example, the target trajectory is expressed as a sequence of points (track points) to which the vehicle M needs to arrive. The track points are points to which the vehicle M needs to arrive for each predetermined traveling distance (for example, about several [m]) in a distance along the road. In addition, apart from that, a target speed and a target acceleration for each predetermined sampling time (for example, about 0 commas [sec]) are generated as a part of the target trajectory. Furthermore, the track points may be positions in which the vehicle M needs to arrive at this sampling time for each predetermined sampling time. In this case, information on the target speed and the target acceleration is represented by an interval between the track points.

The action plan generation unit 140 may set an event for automatic driving when generating the target trajectory. Examples of the event for automatic driving include a constant-speed traveling event, a low-speed following event, a lane change event, a branch event, a merge event, a takeover event, an automatic traveling parking event for unmanned driving and parking in, for example, a valet parking, and the like. The action plan generation unit 140 generates a target trajectory according to the started-up event. The action plan generation unit 140 includes an automatic traveling parking control unit 142 starting-up when the automatic traveling parking event is performed. Detailed of a function of the automatic traveling parking control unit 142 will be described later.

The second control unit 160 controls the traveling driving force output device 200, the brake device 210, and the steering device 220 so that the vehicle M passes along the target trajectory generated using the action plan generation unit 140 at a scheduled time.

Referring to FIG. 2 again, the second control unit 160 includes, for example, an acquisition unit 162, a speed control unit 164, and a steering control unit 166. The acquisition unit 162 acquires information on a target trajectory (a track point) generated using the action plan generation unit 140 and stores the information in a memory (not shown). The speed control unit 164 controls the traveling driving force output device 200 or the brake device 210 on the basis of a speed element associated with a target trajectory stored in the memory. The steering control unit 166 controls the steering device 220 in accordance with a degree of bending of the target trajectory stored in the memory. The processing of the speed control unit 164 and the steering control unit 166 is realized, for example, through a combination of feedforward control and feedback control. As an example, the steering control unit 166 performs a combination of feedforward control according to a curvature of a road in front of the vehicle M and feedback control based on a deviation from the target trajectory.

The traveling driving force output device 200 outputs a traveling driving force (a torque) using which the vehicle travels to driving wheels. The traveling driving force output device 200 includes, for example, a combination of an internal combustion engine, an electric motor, a speed changer, and the like and an electronic control unit (ECU) configured to control these units. The ECU controls the above constitution in accordance with information input from the second control unit 160 or information input from the driving operator 80.

The brake device 210 includes, for example, a brake caliper, a cylinder configured to transmit hydraulic pressure to the brake caliper, an electric motor configured to generate hydraulic pressure to the cylinder, and a brake ECU. The brake ECU controls the electric motor in accordance with information input from the second control unit 160 or information input from the driving operator 80 so that a braking torque according to a braking operation is output to wheels. The brake device 210 may include, as a backup, a mechanism for transmitting hydraulic pressure generated through an operation of the brake pedal included in the driving operator 80 to the cylinder via a master cylinder. The brake device 210 may be an electronically controlled hydraulic brake device configured to control an actuator in accordance with information input from the second control unit 160 and transmit hydraulic pressure of the master cylinder to the cylinder, without being limited to the constitution described above.

The steering device 220 includes, for example, a steering ECU and the electric motor.

For example, the electric motor changes a direction of steered wheels by applying a force to a rack and pinion mechanism. The steering ECU changes a direction of the steered wheels by driving the electric motor in accordance with information input from the second control unit 160 or information input from the driving operator 80.

### [Automatic Traveling Parking Event-at Time of Entering Parking Lot]

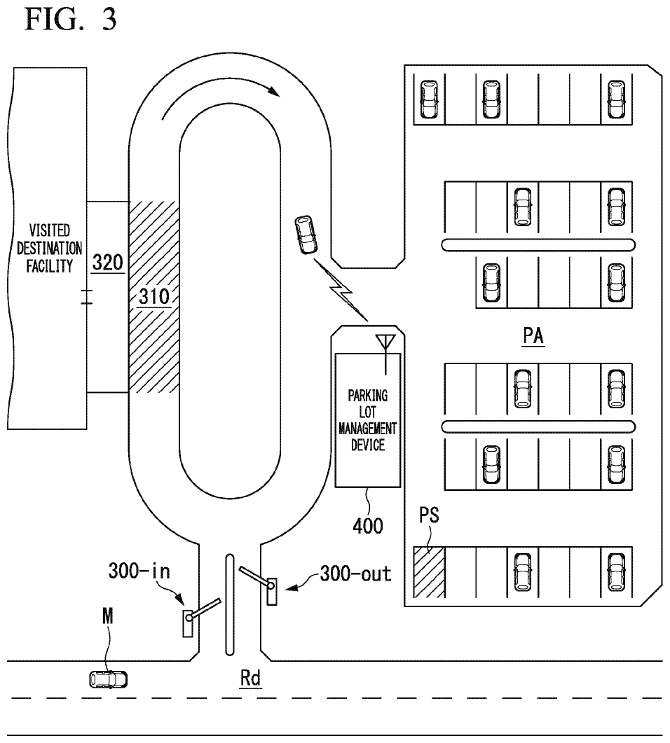

For example, the automatic traveling parking control unit 142 causes the vehicle M to park in a parking space on the basis of information acquired from a parking lot management device 400 using the communication device 20. FIG. 3 is a diagram schematically illustrating a scene in which an automatic traveling parking event is performed.

Gates 300-in and 300-out are provided in a route from a road Rd to a visited destination facility in FIG. 3. The vehicle M passes through the gate 300-in and moves to a stop area 310 through manual driving or automatic driving. The stop area 310 faces a getting-on/off area 320 connected to the visited destination facility. An eave configured to provide a shelter from rain or snow is provided in the getting-on/off area 320. In the getting-on/off area 320, a getting-on-only area and a getting-off-only area may be provided or a getting-on-only area and a getting-off-only area may be changed in accordance with the presence or absence of a user who wants to use them or the number of users who want to use them. In the following description, in the getting-on/off area 320, a fixed getting-on-only area and a fixed getting-off-only area are not particularly provided and a description will be provided assuming that the getting-on/off area 320 is used by both a getting-on user and a getting-off user. Furthermore, a camera C configured to capture a user of the getting-on/off area 320 is provided. An image captured by the camera C is transmitted to, for example, the parking lot management device 400, a billing device 500, each vehicle, and the like, and is used for recognizing a user. The stop area 310 and the getting-on/off area 320 are examples of a “getting-on/off region.”

In the following description, a description will be provided assuming that a valet parking type is employed in a part or all of a parking lot PA. The user of the vehicle M makes a use reservation including a reservation start time and a reservation end time of the parking lot PA in advance with respect to the parking lot management device 400, for example, at a timing at which the schedule in a visited destination facility has been determined, at a time at which a user starts to get in the vehicle M, at a timing at which the vehicle M starts moving toward a visited destination facility, or the like. The parking lot management device 400 may receive a vehicle or a user without a reservation. In this case, the parking lot management device 400 may give an authority to preferentially use facilities in the parking lot PA to a reserved vehicle and user or apply a discount of an advance reservation to a parking fee.

When the vehicle M is caused to enter a parking lot of a valet parking type, the user stops the vehicle M at a dedicated position (hereinafter referred to as a “stop area 310”) in front of a parking space and gets off the vehicle M using the getting-on/off area 320 adjacent to the stop area 310. When the vehicle M has entered the parking lot of a valet parking type, the user gets on the vehicle M using the getting-on/off area 320 similarly when getting on.

The parking lot management device 400 also receives a use reservation of the getting-on/off area 320 in which a user of the vehicle M gets on/off the vehicle M, in addition to a use reservation of a parking space in which the vehicle M is parked. The use reservation of the getting-on/off area 320 may be made so that an absolute reservation schedule is set, for example, from “13:04:30 to 13:04:50” or a reservation schedule having a width such as “30 [sec] at maximum from 13:00 to 13:10” is set.

After the user gets off the vehicle M in the stop area 310, the vehicle M automatically drives in an unmanned manner and starts an automatic traveling parking event in which the vehicle M moves to a parking space PS in the parking lot PA. A start trigger of the automatic traveling parking event may be, for example, any operation by the user or may be a predetermined signal wirelessly received from the parking lot management device 400. When the automatic traveling parking event starts, the automatic traveling parking control unit 142 controls the communication device 20 such that it transmits a parking request to the parking lot management device 400. Furthermore, the vehicle M moves from the stop area 310 to the parking lot PA in accordance with the guidance of the parking lot management device 400 or while sensing by itself.

A timing at which the vehicle M starts using the parking lot PA may not be the same time as a start time of a user using the getting-on/off area 320. For example, the user may cause the vehicle M to travel to the getting-on/off area 320 and alight from the vehicle M before parking. After the user gets off the vehicle M, the vehicle M may be parked in a standby space near the stop area 310 until a parking space for a subject vehicle is secured in the parking lot PA using the parking lot management device 400 or may stand outside the parking lot PA.

When the vehicle M waits outside the parking lot PA until a parking space is secured, it is also possible to utilize a time until the parking lot management device 400 receives a notification that an empty space has been created while replenishing drive source energy, cleaning the interior of the vehicle, and autonomously traveling as a shared car or taxi.

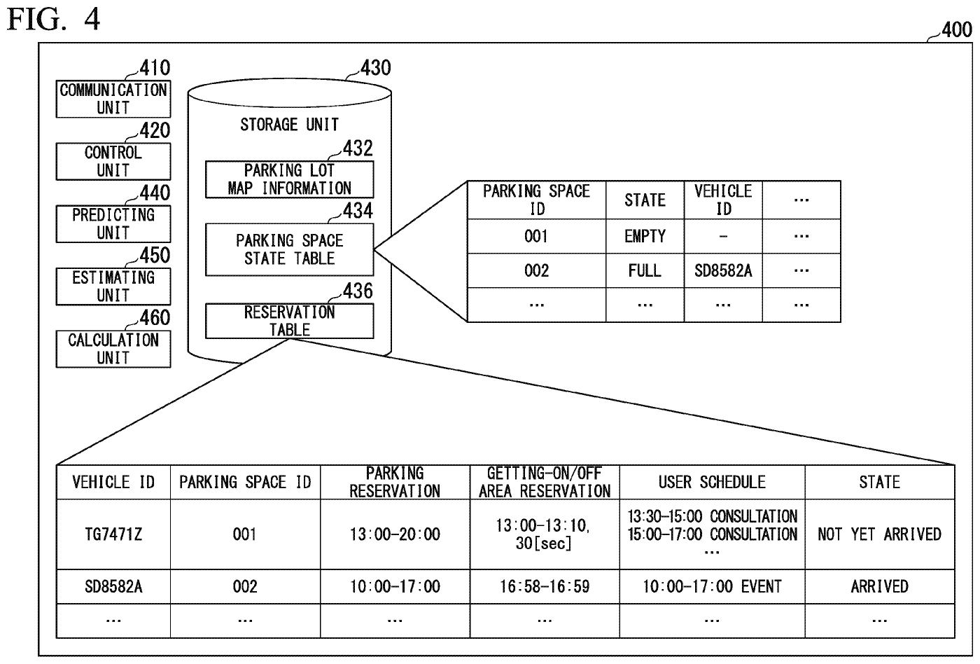

FIG. 4 is a diagram illustrating an example of a constitution of the parking lot management device 400. The parking lot management device 400 includes, for example, a communication unit 410, a control unit 420, a storage unit 430, a predicting unit 440, an estimating unit 450, and a calculation unit 460. The storage unit 430 stores information on parking lot map information 432, a parking space state table 434, a reservation table 436, and the like.

The communication unit 410 wirelessly communicates with the vehicle M and other vehicles. The control unit 420 guides the vehicle to the parking space PS on the basis of information acquired using the communication unit 410 and information stored in the storage unit 430. The parking lot map information 432 is information which geometrically represents a structure of the parking lot PA. Furthermore, the parking lot map information 432 includes coordinates for each parking space PS. The parking space state table 434 includes, for example, a state indicating whether a parking space is empty or full (parked), and a parking space ID which is identification information of the parking space PS, which is associated with a vehicle ID which is identification information of a parked vehicle when a parking space is full. The reservation table 436 is a table in which a reservation time and the vehicle ID are associated with the parking space ID. For example, when a user schedule has been acquired via the user terminal T at the time of reservation, the reservation table 436 may also store the schedule.

Also, the reservation table 436 stores, as a use reservation, a parking reservation corresponding to a use reservation of the parking lot PA, a getting-on/off area reservation corresponding to a use reservation of the getting-on/off area 320, and the like.

The communication unit 410 receives a reservation including a reservation start time at which the vehicle M will enter the parking lot PA and a reservation including designation of a reservation end time at which the vehicle M will leave the parking lot PA. The communication unit 410 receives, for example, an advance reservation for using a parking lot from the user via the user terminal T or via the vehicle M. Furthermore, the communication unit 410 receives a parking lot leaving request including a scheduled getting-on time of the user via the vehicle M or the user terminal T. The parking lot leaving request includes, for example, a scheduled parking lot leaving request.

The communication unit 410 is an example of a “receiving unit.”

If the communication unit 410 receives a parking request from the vehicle, the control unit 420 extracts a parking space PS whose state is empty with reference to the parking space state table 434, acquires a position of the extracted parking space PS from the parking lot map information 432, and transmits an appropriate route to the acquired position of the parking space PS to the vehicle using the communication unit 410. Furthermore, the control unit 420 instructs a specific vehicle to stop or move slowly as necessary so that a plurality of vehicles do not move to the same position at the same time on the basis of positional relationships between the vehicles.

In a vehicle which has received a route (hereinafter referred to as a “vehicle M”), the automatic traveling parking control unit 142 generates a target trajectory based on the route. Furthermore, if the vehicle M approaches a parking space PS which is a target, the parking space recognition unit 132 recognizes parking frame lines or the like which partition the parking space PS, recognizes a detailed position of the parking space PS, and provides the recognized information to the automatic traveling parking control unit 142. The automatic traveling parking control unit 142 receives such information, corrects the target trajectory, and causes the vehicle M to park in the parking space PS.

The predicting unit 440 predicts a time at which the vehicle M will arrive at the parking lot PA in accordance with the arrival of the vehicle M at a predetermined position. The predetermined position is a position on a road in which the time at which the vehicle M arrives at the parking lot PA can be predicted and is set at a point of 3 [km] from the parking lot PA, at a point of 1.5 [km] from the parking lot PA, at five intersections before arriving at the parking lot PA in the route, and the like. The predicting unit 440 acquires position information positioned by the GNSS receiver 51 of the vehicle M via the communication unit 410 and predicts an arrival time. The predicting unit 440 acquires traffic information around the parking lot PA and the like, in addition to positioning information of the vehicle M and predicts an arrival time of the vehicle M.

The estimating unit 450 estimates a congested state of the parking lot PA in the future with reference to the parking space state table 434 and the reservation table 436 of the storage unit 430. The estimating unit 450 may estimate a congested state on the basis of a usage state in the past of the parking lot PA. The congested state may be expressed in stages such as “congested, somewhat congested, and free spaces,” may be numerically represented by the number of vehicles traveling in passages in a parking lot, or may be represented in percentage notation according to an operational rate of the stop area 310 in a parking lot, and the like.

The calculation unit 460 calculates a parking fee in accordance with a time at which the vehicle M is parked in the parking lot PA or a time at which the use of the parking lot PA is reserved.

The control unit 420 performs control so that a determination concerning whether the reservation start time of the vehicle M can be made earlier than the previously received reservation start time and thus the vehicle M is allowed to enter the parking lot PA is performed when an arrival time predicted by the predicting unit 440 is earlier than a reservation start time received through the communication unit 410 and at least one of a reservation start time and a reservation end time is changed when it is determined that the reservation start time can be changed to be earlier.

### [Automatic Traveling Parking Event-at Time of Leaving Parking Lot]

The automatic traveling parking control unit 142 and the communication device 20 are kept in an operating state also while the vehicle M is parked. The automatic traveling parking control unit 142 causes a system of the vehicle M to start-up, for example, when the communication device 20 receives a pick-up request from a terminal device of the user and causes the vehicle M to move to the stop area 310. At this time, the automatic traveling parking control unit 142 controls the communication device 20 such that a start request is transmitted to the parking lot management device 400. The control unit 420 in the parking lot management device 400 instructs a specific vehicle to stop or move slowly as necessary so that a plurality of vehicles do not advance to the same position at the same time on the basis of a positional relationship between the plurality of vehicles in the same manner as at the time of entering the parking space. If the vehicle M is caused to move to the stop area 310 and the user gets on the vehicle M, the automatic traveling parking control unit 142 stops the operation and then manual driving or automatic driving through another functional unit is started.

The present is not limited to the above description, and the automatic traveling parking control unit 142 may find an empty parking space by itself on the basis of the detection results using the camera 10, the radar device 12, the finder 14, or the object recognition device 16 regardless of communication and park the vehicle M in the found parking space.

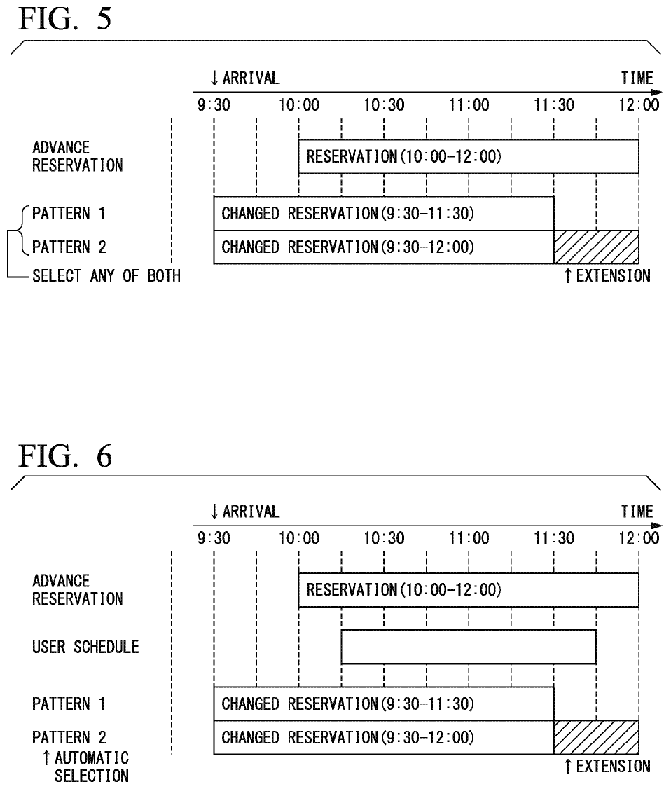

A processing example of the parking lot management device 400 when the vehicle M arrives earlier than a reservation start time will be described below with reference to FIGS. 5 to 8. In the following description, a “reservation time” will be used to include designation of a reservation start time for the parking lot PA and designation of a scheduled staying duration or a scheduled exit time.

[Case 1 in which Vehicle has Arrived Before Reservation Time]

FIG. 5 is a diagram for explaining an example of changing a reservation start time. The communication device 20 in the vehicle M transmits a notification that the vehicle M is about to arrive to the parking lot management device 400 at a timing at which the vehicle M has arrived at a predetermined position. The communication unit 410 in the parking lot management device 400 receives a notification from the vehicle M and outputs the notification to the predicting unit 440. The predicting unit 440 predicts an arrival time of the vehicle M and outputs the arrival time to the estimating unit 450 when the arrival time deviates from a reservation start time at the time of reservation by a predetermined time or more (for example, about 10 [min]). The estimating unit 450 estimates a congested state of the parking lot PA at the arrival time of the vehicle M. The control unit 420 determines whether the reservation start time of the vehicle M can be made earlier than the previously received reservation start time and thus the vehicle M is allowed to enter the parking lot PA on the basis of the estimation results using the estimating unit 450. For example, when the estimation results using the estimating unit 450 are less than a predetermined degree of crowded, the control unit 420 determines whether the reservation start time of the vehicle M can be made earlier than the previously received reservation start time and thus the vehicle M is allowed to enter the parking lot PA. The predetermined degree of congestion may be set to a fixed degree or may be dynamically changed using the control unit 420. When the predetermined degree of congestion is dynamically changed, the control unit 420 sets a predetermined degree of congestion, for example, so that a degree of congestion is made uniform or times of use are not extremely concentrated on the basis of the transition of the degree of congestion (for example, a degree of congestion for every 15 [min]) in a plurality of time periods. Furthermore, when the estimation results of the degree of congestion at the arrival time are compared with the estimation results of the degree of congestion at the reservation start time and it is determined that a degree of congestion at an arrival time is lower than the degree of congestion at the reservation start time, the control unit 420 may determine that the reservation start time of the vehicle M can be made earlier than the previously received reservation start time and thus the vehicle M is allowed to enter the parking lot PA.

The control unit 420 determines whether the reservation start time of the vehicle M can be made earlier than the previously received reservation start time on the basis of a determination concerning whether use reservations of both of the getting-on/off area 320 and the parking lot PA are possible and thus the vehicle M is allowed to enter the parking lot PA. That is to say, when the reservation start time is made earlier than the previously received reservation start time, the control unit 420 performs a determination concerning whether the getting-on/off area 320 can be used by including the determination in determination conditions. For example, when the vehicle M can be permitted to use both of the getting-on/off area 320 and the parking lot PA even if the reservation start time is made earlier than the previously received reservation start time, the control unit 420 determines that the reservation start time of the vehicle M is made earlier than the previously received reservation start time and thus the vehicle M is allowed to enter the parking lot PA.

When the control unit 420 determines that a change in which the reservation start time is made earlier than the previously received reservation start time is possible, the user selects changing at least one of the reservation start time and the reservation end time. For example, the user may perform a determination that the reservation end time be made earlier than the previously received reservation end time by the time at which the reservation start time is made earlier than the previously received reservation start time without changing the scheduled stay time (a pattern 1 in FIG. 5) and may perform a determination so that the scheduled stay time is increased by the time at which the reservation start time is made earlier than the previously received reservation start time without changing the reservation end time (a pattern 2 in FIG. 5). The user inputs details of the scheduled exit time set to any of the pattern 1 and the pattern 2 in FIG. 5 via the HMI 30 or the user terminal T.

[Case 2 in which Vehicle Arrives at Parking Lot Before Reservation Time]

Also, when the user schedule has been obtained in advance, the control unit 420 may determine whether the reservation end time is also made earlier than the previously received reservation end time (whether to change the reservation end time) on the basis of the user schedule. FIG. 6 is a diagram for explaining another example of changing a reservation start time. As illustrated in FIG. 6, when the user schedule is tight until 11:45, the control unit 420 may determine that the pattern 2 in which the reservation end time of the vehicle M is not changed is more preferable than the pattern 1 in which the reservation end time is made earlier than the previously received reservation end time by the time at which the reservation start time is made earlier than the previously received reservation start time and may determine not to automatically change the reservation end time (to increase the scheduled stay time).

[Case 3 in which Vehicle Arrives at Parking Lot Before Reservation Time]

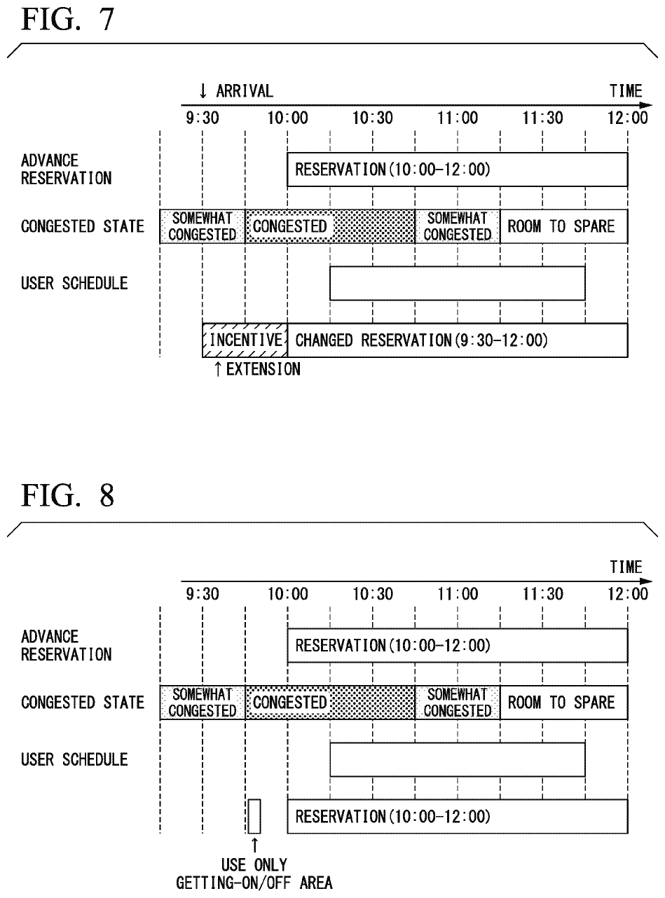

Also, the control unit 420 may determine whether the reservation start time is made earlier than the previously received reservation start time on the basis of the estimation results of a congested state using the estimating unit 450. FIG. 7 is a diagram for explaining another example of changing a reservation start time.

When the congested state at the reservation start time estimated using the estimating unit 450 is less than a predetermined degree of congestion, the control unit 420 determines whether a change in which the reservation start time is made earlier than the previously received reservation start time is possible. For example, as illustrated in FIG. 7, when a degree of congestion of a congested state in which an arrival time is 9:30 is lower than that of a congested state in which the original reservation start time of the vehicle M is 10:00, the control unit 420 recommends the vehicle M to make the reservation start time earlier than the previously received reservation start time to alleviate the congested in the parking lot PA and shift the peak. In this case, the calculation unit 460 applies an incentive to the vehicle M. For example, when it is determined that a change in which the reservation start time is made earlier than the previously received reservation start time is possible and it is recommended that the reservation start time is made further earlier than the previously received reservation start time, the incentive is calculating a parking fee by regarding the reservation start time received in advance as a use start time, and in the example illustrated in FIG. 7, is a reward for shifting the peak such as not generating a parking fee from 9:30 to 10:00 or applying a discount to a parking fee from 9:30 to 10:00.

[Case in which Vehicle Arrives at Parking Lot Before Reservation Time and Cannot Use Parking Lot]

When the reservation start time is made earlier than the previously received reservation start time, the control unit 420 can permit the vehicle M to use the getting-on/off area 320, but cannot cause the vehicle M to enter the parking lot PA because there is no empty space in the parking lot PA. In addition, the control unit 420 confirms the user's intention to get off the vehicle via the HMI 30 of the vehicle M or the user terminal T when a standby time occurs until the vehicle can enter the parking lot. FIG. 8 is a diagram for explaining another example of changing a reservation start time. The user may select waiting in the vehicle until an empty space in the parking lot PA is created, may select making the vehicle M stand by in an empty space near the getting-on/off area 320, or may select waiting around a visited destination facility.

In the example illustrated in FIG. 8, when a degree of congestion of the reservation start time is compared with a degree of congestion of the arrival time and it is determined that the degree of congestion of the arrival time is higher on the basis of the comparison result (that is, when the user of the vehicle M receives the benefit of shortening a parking lot entry waiting time), the calculation unit 460 may add an additional charge equal to or more than a charge corresponding to a time at which a parking time is made earlier. Furthermore, when the degree of congestion of the reservation start time is compared with the degree of congestion of the arrival time and it is determined that there is no significant difference between the degrees of congested, the calculation unit 460 may add a parking fee corresponding to a time at which a parking time is increased.

[Case in which Vehicle Leaves Parking Lot Before Reservation End Time]

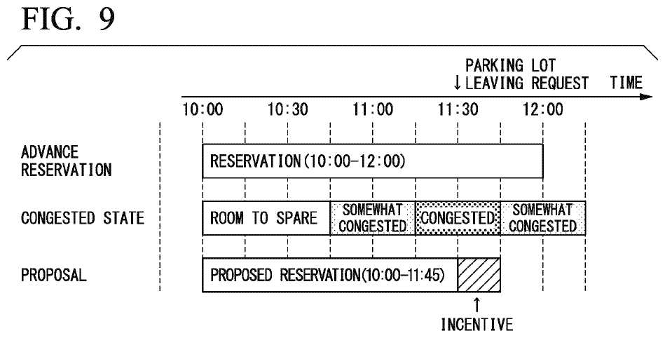

A processing example of the parking lot management device 400 when the vehicle M leaves the parking lot before the reservation end time will be described below with reference to FIG. 9. FIG. 9 is a diagram for explaining an example of changing a reservation end time.

When a scheduled getting-on time received by the communication unit 410 is earlier than a reservation end time received in advance, the control unit 420 determines whether the vehicle M can exit from the parking lot PA at the scheduled getting-on time. In addition, when it is determined that the vehicle M can exit from the parking lot PA at the scheduled getting-on time, the control unit 420 performs control so that the reservation end time is changed to the scheduled getting-on time. The scheduled getting-on time is set, for example, when the vehicle M receives a parking lot leaving request via the user terminal T. The user transmits a parking lot leaving request including a time designation such as the expressions “I want you to go to the getting-on/off area 320 right now” and “I want you to pick me up at the getting-on/off area 320 at 12:00” to the vehicle M. The vehicle M transmits the receipt of the parking lot leaving request to the parking lot management device 400

The control unit 420 determines whether a use assignment of the getting-on/off area 320 is possible in accordance with the parking lot leaving request and changes the reservation end time of the use reservation of the getting-on/off area 320 of the vehicle M when it is determined that a use assignment is possible. When a use assignment of the getting-on/off area 320 according to the parking lot leaving request is not possible, the control unit 420 causes the vehicle M to transmit a temporary standby command and performs adjustment so that congestion does not occur in the parking lot PA by causing the user terminal T to transmit candidate information or the like on a time at which the use assignment of the getting-on/off area 320 is possible to the vehicle M.

When a reserved reservation end time is changed to the scheduled getting-on time, the calculation unit 460 may calculate a parking fee assuming that the vehicle M has been parked until the original reserved reservation end time or may calculate a parking fee using a time from a time at which the vehicle M passes through the gate 300-in to a time at which the vehicle M passes through the gate 300-out as a parking time.

Also, the control unit 420 may determine whether the vehicle M is allowed to leave the parking lot PA at the scheduled getting-on time in accordance with the estimation results of the congested state using the estimating unit 450. For example, if the congested state at the scheduled getting-on time is estimated by the estimating unit 450 as being less than a predetermined degree of congestion, the control unit 420 determines whether a change in which the reservation end time is made earlier to the scheduled getting-on time is possible.

The predetermined degree of congestion may be set to a fixed degree as in the degree of congestion used when the vehicle enters the parking lot or may be dynamically changed using the control unit 420. Furthermore, when the estimation result of the degree of congestion at the reservation end time is compared with the estimation result of the degree of congestion at the scheduled getting-on time and it is determined that the degree of congestion at the scheduled getting-on time is lower than the degree of congestion at the reservation end time, the control unit 420 may determine that the reservation end time of the vehicle M is made earlier than the previously received reservation end time and thus the vehicle M is allowed to leave the parking lot PA. For example, as illustrated in FIG. 9, when the congested state at the scheduled getting-on time received through the communication unit 410 is higher than the congested state at the original reserved reservation end time, the user of the vehicle M is asked to change the scheduled getting-on time and the congested state in the parking lot PA is adjusted. The calculation unit 460 applies an incentive to a parking fee of the vehicle M of the user who has determined to change the reservation end time at a time at which the degree of congestion is low or to a parking fee of the vehicle M of the user who has determined to cancel the change of the reservation end time at a time at which the degree of congestion is high. The incentive mentioned herein means, for example, causing the calculation unit 460 to calculate a parking fee by regarding a scheduled getting-on time as a use end time.

Similarly to when the vehicle M arrives, when the degree of congestion at the reservation end time is compared with the degree of congestion at the scheduled getting-on time and it is determined that the degree of congestion at the scheduled getting-on time is higher on the basis of the comparison result, the calculation unit 460 (that is, when the user of the vehicle M receives the benefit of shortening a parking lot leaving waiting time), the calculation unit 460 may not perform a calculation in which a fee corresponding to a time at which a parking time is shortened is subtracted. Furthermore, when the degree of congestion at the reservation end time is compared with the degree of congestion at the scheduled getting-on time and it is determined that there is no significant difference between the degrees of congested, the calculation unit 460 may subtract a parking fee corresponding to a time at which a parking time is made to be earlier.

### [Processing Flow-when Vehicle Enters Parking Lot]

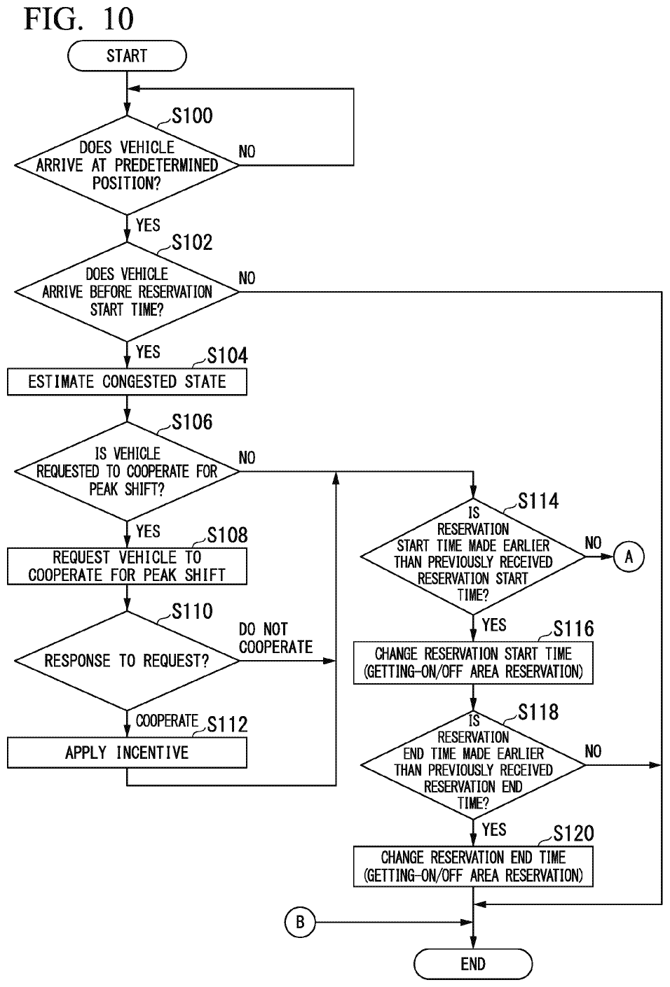

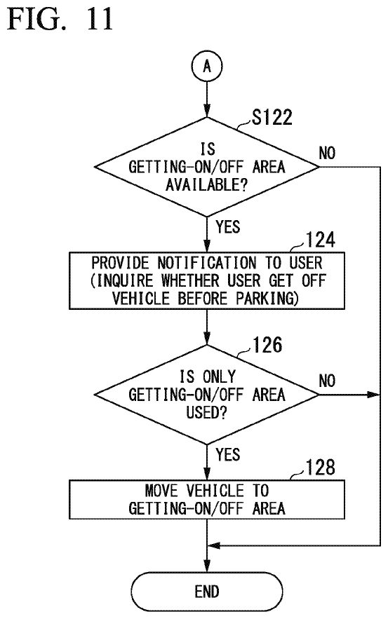

FIGS. 10 and 11 are flowcharts illustrating an example of a flow of a parking lot entry process of the parking lot management device 400.

First, the communication unit 410 determines whether a notification that the vehicle M has arrived at a predetermined position has been received (Step S100). When it is determined that the notification has not been received, the communication unit 410 performs the process of Step S100 again after a predetermined time has elapsed. When it is determined that the notification has been received, the predicting unit 440 predicts the arrival time of the vehicle M and predicts whether the vehicle M arrives before the reservation start time (Step S102). When the vehicle M is predicted to arrive after the reservation start time, the predicting unit 440 ends the process. When the vehicle M is predicted to arrive before the reservation start time, the estimating unit 450 estimates the reservation start time and the congested state of the parking lot PA at the arrival time of the vehicle M (Step S104).

Subsequently, the control unit 420 determines whether to request the vehicle M to cooperate for the peak shift, that is, whether to request the vehicle M to change the reservation start time with reference to the estimation results using the estimating unit 450 (Step S106). When it is determined not to request the cooperation of the peak shift, the process proceeds to Step S114 which will be described later. When it is determined that a request for peak shift cooperation is to be made, the control unit 420 transmits a request for peak shift cooperation to the user terminal T or the vehicle M via the communication unit 410 (Step S108).

When a response to cooperate is obtained as a result of requesting the cooperation of the peak shift, the calculation unit 460 determines to apply an incentive to the vehicle M (Step S112).

When a response to cooperate is not obtained as a result of requesting the cooperation of the peak shift, the control unit 420 determines whether the reservation start time is made earlier than the previously received reservation start time (Step S114). When it is determined that the reservation start time is made earlier than the previously received reservation start time, the control unit 420 changes the reservation start time of the vehicle M (Step S116). The change in the reservation start time in Step S116 includes a change in use reservation time of the getting-on/off area 320.

Subsequently, the control unit 420 determines whether the reservation end time is made earlier than the previously received reservation end time in accordance with the change in the reservation start time (Step S118). The process of Step S118 may be a process of receiving an input by the user or may be determined by the control unit 420 on the basis of a user schedule. When it is determined that the reservation end time is made earlier than the previously received reservation end time, the control unit 420 changes the reservation end time and the use reservation of the getting-on/off area 320 accompanied by this (Step S120). When it is not determined that the reservation end time is made earlier than the previously received reservation end time, the process ends.

Referring to FIG. 11 again, when it is not determined in Step S114 that the reservation start time is made earlier than the previously received reservation start time, the control unit 420 determines whether the getting-on/off area 320 can be used before the reservation start time in a case in which it is determined that a change in which the reservation start time is made earlier than the previously received reservation start time is not possible because there is no empty space in the parking lot PA (Step S122). When it is determined that the getting-on/off area 320 cannot be used before the reservation start time, the process ends. When it is determined that the getting-on/off area 320 can be used before the reservation start time, the control unit 420 provides a notification of information of the user terminal T or the vehicle M via the communication unit 410, thereby inquiring whether the user gets off the vehicle before parking (Step S124).

Subsequently, the control unit 420 receives the result of the inquiry in Step S124 (Step S126). When the user does not get off the vehicle before parking, the process ends. When the user uses the getting-on/off area 320 to get off the vehicle before parking, even before the reservation start time, the vehicle M is caused to move to the getting-on/off area 320 and after the user gets off the vehicle, the vehicle M is caused to wait until the parking space is free (Step S128). Here, the description of the process of this flowchart ends.

[Processing Flow when Vehicle Leaves Parking Lot]

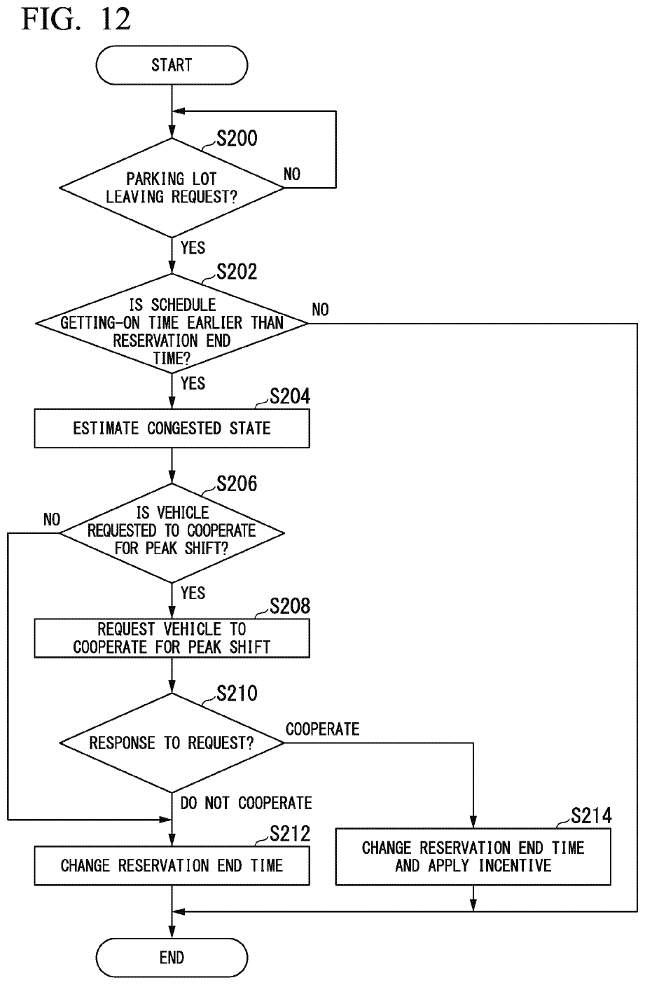

FIG. 12 is a flowchart for describing an example of a flow of a parking lot leaving process of the parking lot management device 400.

First, the communication unit 410 determines whether a parking lot leaving request has been received from the vehicle M or the user terminal T (Step S200). When it is not determined that the parking lot leaving request has been received, the process of Step S200 is performed again after a predetermined time has elapsed. When it is determined that the parking lot leaving request has been received, the control unit 420 determines whether a scheduled getting-on time included in the parking lot leaving request is earlier than the reservation end time or is the same as the reservation end time (or exceeds the reservation end time) (Step S202). When it is determined that the scheduled getting-on time is the same as the reservation end time, the process ends. When it is determined that the scheduled getting-on time is earlier than the reservation end time, the estimating unit 450 estimates congested states of the parking lot PA at the reservation end time and the scheduled getting-on time (Step S204). When it is determined in Step S202 that the scheduled getting-on time exceeds the reservation end time, the control unit 420 may cause the calculation unit 460 to additionally calculate a fee corresponding to a time which has been exceeded (extended) (hereinafter referred to as an “excess fee.”) and cause the vehicle M to charge the excess fee in accordance with a parking fee corresponding to a normal charge.

Subsequently, the control unit 420 determines whether to request the vehicle M to cooperate in the peak shift with reference to the estimation results using the estimating unit 450 (Step S206). When it is determined not to request the cooperation of the peak shift, the process proceeds to the process of Step S212. When it is determined to request the cooperation of the peak shift, the control unit 420 transmits a request for peak shift cooperation to the user terminal T or the vehicle M via the communication unit 410 (Step S208).

When a response to cooperate is not obtained as a result of requesting the cooperation of the peak shift, the control unit 420 changes the reservation end time of the vehicle M (Step S212). When a response to cooperate is obtained as a result of requesting the cooperation of the peak shift, the calculation unit 460 changes the reservation end time and further determines that an incentive is applied to the vehicle M (Step S214). The change in the reservation end time in Steps S212 and S214 includes a change in the use reservation time of the getting-on/off area 320. Here, the description of this flowchart ends.

As described above, according to the parking lot management device 400, when the communication unit 410 receives a reservation time including designations of a reservation start time at which the vehicle M enters the parking lot PA and a reservation end time at which the vehicle M leaves the parking lot PA, the predicting unit 440 predicts a time at which the vehicle M arrives at the parking lot PA in accordance with the arrival of the vehicle M at a predetermined position, and the arrival time predicted by the predicting unit 440 is earlier than the reservation start time received by the control unit 420 in advance, it is determined whether the reservation start time can be made earlier than the previously received reservation start time so that the vehicle M is caused to enter the parking lot PA. In addition, when it is determined that a change in which the reservation start time is made earlier than the previously received reservation start time is possible, it is possible to more flexibly receive a change in the reservation time for using the parking lot of the vehicle M and it is possible to alleviate the congested in the parking lot PA and make an appropriate use assignment of the getting-on/off area 320 by performing control so that at least one of the reservation start time and the reservation end time is changed.

### [Hardware Constitution]

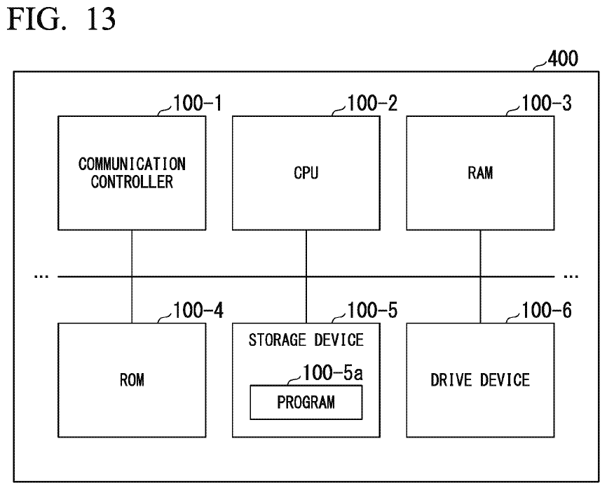

FIG. 13 is a diagram illustrating an example of a hardware constitution of the parking lot management device 400 in the embodiment. As illustrated in the drawings, the parking lot management device 400 has a constitution in which a communication controller 100-1, a CPU 100-2, a random access memory (RAM) 100-3 used as a working memory, a read only memory (ROM) 100-4 configured to store a boot program and the like, a storage device 100-5 such as a flash memory and an HDD, a drive device 100-6, and the like are connected to each other through an internal bus or a dedicated communication line. The communication controller 100-1 communicates with constituent elements other than the automatic driving control device 100. The storage device 100-5 stores a program 100-5a executed by the CPU 100-2. This program is developed in the RAM 100-3 by a direct memory access (DMA) controller (not shown) or the like and is executed by the CPU 100-2. Thus, a part or all of the parking lot management device 400 are realized.

The embodiment described above can be expressed as follows.

A parking lot management device including:

a storage device configured to store a program; and

a hardware processor,

wherein the hardware processor executes a program stored in the storage device so that a reservation including designations of a reservation start time at which a vehicle enters a parking lot and a reservation end time at which the vehicle leaves the parking lot and a parking lot leaving request including a scheduled getting-on time of a user of the vehicle getting on the vehicle are received,

an arrival time of the vehicle at the parking lot in accordance with the arrival of the vehicle at a predetermined position is predicted,

when the predicted arrival time is earlier than the reservation start time, it is determined whether the reservation start time is made earlier than a previously received reservation start time so that the vehicle can enter the parking lot, and when it is determined that a change in which the reservation start time is made earlier than the previous received reservation start time is possible, control is performed so that at least one of the reservation start time and the reservation end time is changed, and

when the scheduled getting-on time is earlier than the reservation end time, a determination concerning whether the vehicle is allowed to leave the parking lot at the scheduled getting-on time is performed, and when it is determined that the vehicle is allowed to leave the parking lot at the scheduled getting-on time, control is performed so that the reservation end time is changed to the scheduled getting-on time.

Although an aspect for carrying out the present invention has been described above using the embodiment, the present invention is not limited to such embodiment at all and various modifications and substitutions are possible without departing from the gist of the present invention.

What is claimed is:

1. A parking lot management device, comprising:
a receiving unit configured to receive a reservation including designations of a reservation start time at which a vehicle enters a parking lot and a reservation end time at which the vehicle leaves the parking lot;
a predicting unit configured to predict an arrival time at the parking lot in accordance with the arrival of the vehicle at a predetermined position; and
a control unit configured to perform control so that, when the arrival time predicted by the predicting unit is earlier than the reservation start time received by the receiving unit, it is determined whether the reservation start time is made earlier than the previously received reservation start time so that the vehicle is allowed to enter the parking lot, and when it is determined that a change in which the reservation start time is made earlier than the previously received reservation start time is possible, control is performed so that at least one of the reservation start time and the reservation end time is changed.

2. The parking lot management device according to claim 1, wherein the control unit performs control so that a change in which the reservation end time is also made earlier than the previously received reservation end time is performed when the change in which the reservation start time is made earlier than the previously received reservation start time has been performed.

3. The parking lot management device according to claim 1, wherein, when it is determined whether the reservation start time is made earlier than the previously received reservation start time so that the vehicle is allowed to enter the parking lot, the control unit performs a determination concerning whether a getting-on/off region in which a user of the vehicle gets on and off the vehicle is available in the parking lot by including the determination in determination conditions regarding whether the reservation start time can be made earlier than the previously received reservation start time.

4. The parking lot management device according to claim 3, wherein, when the reservation start time has been made earlier than the previously received reservation start time, the control unit causes the vehicle to enter the getting-on/off region on the basis of the reservation start time if the vehicle is not allowed to enter the parking lot and is allowed to enter the getting-on/off region.

5. The parking lot management device according to claim 1, further comprising:
a calculation unit configured to calculate a parking fee in accordance with a time at which the vehicle is parked in the parking lot; and
an estimating unit configured to estimate a congested state of the parking lot in the future,
wherein the estimating unit estimates a congested state at the reservation start time received in advance by the receiving unit and a congested state at the arrival time,
the control unit determines whether a change in which the reservation start time is made earlier than the previously received reservation start time is possible when the estimating unit estimates that the congested state at the reservation start time is equal to or higher than a predetermined degree of congestion and a degree of congestion at the reservation start time is higher than that of the arrival time, and
the calculation unit applies an incentive to the parking fee when the control unit determines that the change in which the reservation start time is made earlier than the previously received reservation start time is possible and the reservation start time of the vehicle is made earlier than the previously received reservation start time.

6. The parking lot management device according to claim 5, wherein the incentive includes calculating the parking fee by regarding the reservation start time received in advance by the receiving unit as a use start time when the control unit determines that the change in which the reservation start time is made earlier than the previously received reservation start time is possible.

7. The parking lot management device according to claim 5, wherein the control unit determines whether the change in which the reservation start time is made earlier than the previously received reservation start time is possible when the congested state at the reservation start time estimated by the estimating unit is less than a predetermined degree of congestion, and
the calculation unit calculates the parking fee using the arrival time as a reservation start time when the control unit determines that the change in which the reservation start time is made earlier than the previously received reservation start time is possible.

8. A parking lot management device, comprising:
a receiving unit configured to receive a reservation including designation of a reservation end time at which a vehicle leaves a parking lot and a parking lot leaving request including a scheduled getting-on time of a user of the vehicle getting on the vehicle; and
a control unit configured to determine whether the vehicle is allowed to leave the parking lot at the scheduled getting-on time when the scheduled getting-on time received by the receiving unit is earlier than the reservation end time received by the receiving unit and to perform control so that the reservation end time is changed to the scheduled getting-on time when it is determined that the vehicle is allowed to leave the parking lot at the scheduled getting-on time.

9. The parking lot management device according to claim 8, wherein the control unit performs a determination concerning whether the vehicle is allowed to leave the parking lot by including a determination concerning whether a getting-on/off region in which the user gets on and off the vehicle is available in the parking lot in determination conditions regarding whether the reservation end time can be made earlier than the previously received reservation end time and makes a reservation so that the vehicle is able to use the getting-on/off region when it is determined that the vehicle is allowed to leave the parking lot at the scheduled getting-on time.

10. The parking lot management device according to claim 8, further comprising:
a calculation unit configured to calculate a parking fee in accordance with a time at which the vehicle is parked in the parking lot; and
an estimating unit configured to estimate a congested state of the parking lot in the future,
wherein the estimating unit estimates a congested state at the reservation end time and a congested state at the scheduled getting-on time,
the control unit determines whether the reservation end time is able to be changed to the scheduled getting-on time earlier than the reservation end time when the estimating unit estimates that the congested state at the reservation end time is equal to or higher than a predetermined degree of congestion and a degree of congestion at the reservation end time is higher than that of the scheduled getting-on time, and
the calculation unit applies an incentive to the parking fee when the control unit determines that a change in which the reservation end time is made earlier than the previously received reservation end time is possible and the reservation end time of the vehicle is made earlier than the previously received reservation end time.

11. The parking lot management device according to claim 10, wherein the incentive includes calculating the parking fee by regarding the scheduled getting-on time as a use end time when the control unit determines that the change in which the reservation end time is able to be changed to the scheduled getting-on time earlier than the reservation end time.

12. The parking lot management device according to claim 10, wherein the control unit determines whether the reservation end time is able to be changed to the scheduled getting-on time earlier than the reservation end time when the congested state at the reservation end time estimated by the estimating unit is less than a predetermined degree of congestion, and
the calculation unit calculates the parking fee in accordance with the reservation end time when the control unit determines that the change in which the reservation end time is made earlier than the previously received reservation end time is possible and the reservation end time of the vehicle is made earlier than the previously received reservation end time.

13. A parking lot management method causing a computer to execute:
receiving a reservation including designations of a reservation start time at which a vehicle enters a parking lot and a reservation end time at which the vehicle leaves the parking lot and a parking lot leaving request including a scheduled getting-on time of a user of the vehicle getting on the vehicle,
predicting an arrival time at the parking lot in accordance with the arrival of the vehicle at a predetermined position,
performing a determination concerning whether the reservation start time is made earlier than the previous received reservation start time so that the vehicle is allowed to enter the parking lot when the predicted arrival time is earlier than the reservation start time and performing control so that at least one of the reservation start time and the reservation end time is changed when it is determined that a change in which the reservation start time is made earlier than the previously received reservation start time is possible, and
performing a determination concerning whether the vehicle is allowed to leave the parking lot at the scheduled getting-on time when the scheduled getting-on time is earlier than the reservation end time and performing control so that the reservation end time is changed to the scheduled getting-on time when it is determined that the vehicle is allowed to leave the parking lot at the scheduled getting-on time.

14. A non-transitory computer-readable storage medium which stores a program causing a computer to execute:
receiving a reservation including designations of a reservation start time at which a vehicle enters a parking lot and a reservation end time at which the vehicle leaves the parking lot and a parking lot leaving request including a scheduled getting-on time of a user of the vehicle getting on the vehicle,
predicting an arrival time at the parking lot in accordance with the arrival of the vehicle at a predetermined position,
performing a determination concerning whether the reservation start time is made earlier than the previous received reservation start time so that the vehicle is allowed to enter the parking lot when the predicted arrival time is earlier than the reservation start time and performing control so that at least one of the reservation start time and the reservation end time is changed when it is determined that a change in which the reservation start time is made earlier than the previously received reservation start time is possible, and
performing a determination concerning whether the vehicle is allowed to leave the parking lot at the scheduled getting-on time when the scheduled getting-on time is earlier than the reservation end time and performing control so that the reservation end time is changed to the scheduled getting-on time when it is determined that the vehicle is allowed to leave the parking lot at the scheduled getting-on time.
